(19) United States
(12) Patent Application Publication
(10) Pub. No.: US 2013/0198715 A1
(43) Pub. Date: Aug. 1, 2013

(54) Selective application view

(71) Applicants: David Zuckerman, San Francisco, CA (US); Rebecca Hyatt, Mountain View, CA (US)

(72) Inventors: David Zuckerman, San Francisco, CA (US); Rebecca Hyatt, Mountain View, CA (US)

(73) Assignee: Adobe Systems Incorporated, San Jose, CA (US)

(21) Appl. No.: 11/545,708

(22) Filed: Oct. 9, 2006

(51) Int. Cl. G06F 9/44

(52) U.S. Cl. CPC G06F 8/70
USPC 717/120

(57) ABSTRACT

A selective outline view is described in an application development environment that allows viewing an outline of an application in either a procedural code outline view or a declarative tree-view. The application is written, at least in part, in a tag-based declarative language. The declarative language has a representational relationship to a procedural language that defines the logic of application. The choice of views is presented in a selection indicator. On selection of the procedural code outline view, the application is processed to obtain a procedural code representation of the application using the relationship between the declarative and procedural languages. The procedural code outline view is generated from the procedural code representation. On selection of the declarative tree-view of the application, the ADE parses the application to obtain a declarative object model of the application. The declarative tree-view of the application is created using the declarative object model.

### TECHNICAL FIELD

The present invention relates, in general, to application development environments (ADES) and, more particularly, to a selective outline view for selectively viewing either a declarative or programmatic view of the application under development.

### BACKGROUND

As the Internet and Internet-related technologies have advanced, Internet content has progressed from simple, static web pages, to complex interactive web applications. Many Internet-related applications and documents are written tag-based, declarative languages, such as hypertext markup language (HTML), extensible markup language (XML), and the like. Web developers often use application development environments (ADEs) specifically designed for web development, such as Adobe Systems Incorporated's DREAMWEAVER®, and GO LIVE®, Microsoft Corporation's FRONTPAGE®, and the like. These ADEs provide an environment to the developer to code web documents using HTML and other declarative languages, such as XML, Adobe Systems Incorporated's CFML™, and the like.

Declarative languages have a structured syntax that can be modeled to provide an outline of a particular document's structure. One model typically used with such declarative languages is called a document object model (DOM). A DOM is a tree structure representation of how the declarative language document is organized. DOM provides an object oriented application programming interface that allows parsing the declarative language into a well defined tree structure and operating on its contents. Many ADEs provide a feature that shows the developer a tree-based view of a declarative language document in addition to the actual code view of the document. The tree-based view, which may be the DOM of the document, provides an organized outline view of the document structure. This type of view is beneficial to the web developers in managing the organization of the entire declarative language document.

While declarative, markup languages are generally used to describe the appearance of web documents, web applications, and the like. Web applications also typically use scripting languages, such as Netscape Communications and Weblogs, Inc.'s JAVASCRIPT™, Sun Microsystems Inc.'s JAVA®, and the like, to provide a certain measure of interactivity in the user interface portion of the application pages, which are generally provided to the user's web browser to deliver the application to the user. Scripting languages are more conventional programming languages that provide the procedural steps and logic for processing that occurs in a Web application interface. The scripting language modules or applets are typically associated with the HTML interface elements displayed on the web browser to provide interactivity with the user. Data entered by the user in the interactive HTML pages is transmitted to a remote web server or application server to process some kind of backend logic into a desired results. The results are then generated into an HTML page and transmitted back to the web browser for display to the user on the browser.

As web technologies have advanced, the partnership of declarative languages and the procedural languages have become more closely related in web application development. In one advance, referred to as asynchronous JAVASCRIPT™ and XML (AJAX), a reference relationship is created between the declarative HTML or dynamic HTML (DHTML) and the procedural JAVASCRIPT™ used in the code defining the web application. For example, with the DHTML document defining the application appearance or interface, certain tags may be identified with HTML IDs. Some of those IDs may be of interest in writing the AJAX code in JAVASCRIPT™. Thus, the IDs in the declarative DHTML code has a particular relationship to the procedural JAVASCRIPT™ code.

Another example of an advanced web application technology is Adobe Systems Incorporated's FLEX™. FLEX™ is a presentation layer server that has an ADE, FLEX BUILDER™, associated with it for creating web applications, such as rich internet applications (RIAs). RIAs are interactive, multimedia, applications, that may run on client-side players or within client-side process containers, for example, Adobe System Incorporated's FLASH® player. FLEX™ and FLEX BUILDER™ utilize Adobe Systems Incorporated's MXML™, an Extensible Markup Language (XML)-based language, to describe RIAs. MXML™ is a tag-based markup language for describing applications. It is practically unique because while it is a tag-based markup language, it not only describes the appearance of a particular web application, it can also describe the procedural logic as well. When an MXML™ document is compiled, it is compiled into ACTIONSCRIPT™, which is a procedural language. Therefore, a direct relationship also exists between the MXML™ markup and the ACTIONSCRIPT™ code.

In ADEs that support such advanced programming, providing a visual structure of the application is beneficial for the developer to maintain an overall organizational view of the application. Most such ADEs provide an outline view that displays the declarative language tree structure to the developer. This feature provides valuable overall information, but it is limited to the declarative language portion of the application.

### BRIEF SUMMARY

Representative embodiments of the present invention are directed to systems, methods, and computer program products for presenting a developer a choice to view an outline of an application in either a procedural code outline view or a declarative tree-view, where the application is written, at least in part, in a tag-based declarative language. The tag-based declarative language has some kind of representational relationship to a procedural language that defines the logic of application. The choice of views is presented to a developer through a selection indicator in an ADE. On selection of the procedural code outline view, the application is processed to obtain a procedural code representation of the application using a relationship between the tags defining the application and the procedural code. The procedural code outline view is generated from the procedural code representation. On selection of the declarative tree-view of the application, the ADE parses the application to obtain a declarative object model of the application. The declarative tree-view of the application is created using the declarative object model.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram illustrating an ADE configured according to one embodiment of the present invention;

FIG. 2A is a screenshot illustrating an ADE configured according to one embodiment of the present invention;

FIG. 2B is a screenshot illustrating an ADE configured according to one embodiment of the present invention;

FIG. 3 is a flowchart illustrating example steps executed to implement one embodiment of the present invention; and

FIG. 4 illustrates a computer system adapted to use embodiments of the present invention.

### DETAILED DESCRIPTION

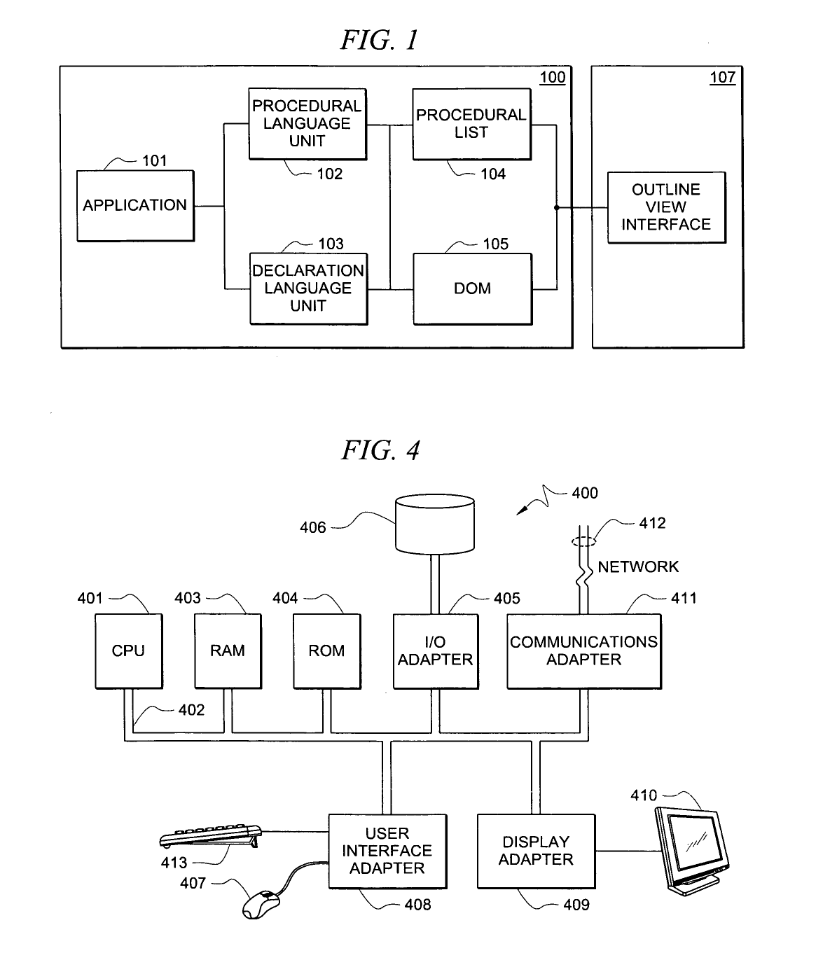

FIG. 1 is a block diagram illustrating ADE 100 configured according to one embodiment of the present invention. An application developer uses ADE 100 to create at web application. The developer uses a tag-based markup language to describe the application. The tag-based markup language used by the developer is a markup language that has a relational association with a procedural language used to implement the logic of the web application. Application 101 represents the location in memory that ADE 100 maintains this application code.

As the developer enters code into ADE 100, he or she views the code edit region on display 107. ADE 100 also includes a interface panel on display 107 that displays an outline view of the overall application to the developer, outline view interface 106. By referring to outline view interface 106, the developer can keep track of the organization of the entire application being developed. Because the markup language used includes a relation to the associated procedural code, ADE offers two separate and distinct views of application 101. The developer may select to view the procedural outline of application 101, which would display the organizational view of the corresponding procedural language for application 101, or may select to view the declarative outline of application 101, which would display the DOM-like tree structure of the declarative language application.

When the developer selects to view the procedural outline, application 101 is processed by procedural language unit 102. Procedural language unit 102 is a software module that parses through the markup tags of application 101 and determines the procedural code attributes that correspond or relate to the parsed tags. The determination of the procedural code attributes may be obtained by accessing a relational data table, which is a data structure that provides the relationship between the tags of the markup language and the procedural language. The results of this determination are stored in procedural list 104. Procedural list 104 is then transmitted to outline view interface 106 to display the procedural outline view to the developer on display 107. In viewing the procedural outline of application 101, the developer sees the classes, variables, functions, objects, and the like that procedurally make up the web application.

In contrast, when the developer selects to view the declarative outline, application 101 is processed by declarative language unit 103. Declarative language unit 103 is another software module that parses through application 101 to determine the tree-structure of the code, much like a DOM of application 101. The result of declarative language unit 103's processing is stored in DOM 105. DOM 105 is then transmitted to outline view interface 106 to display the declarative outline in display 107. By viewing the declarative outline of application 101, the developer sees the various objects, object properties, and the hierarchical relationship of each of those various objects. This view provides more of a physical structural view of application 101 than the procedural outline view. Thus, by providing a selectable outline view to the developer between the procedural outline and the declarative outline, ADE 100 provides a more complete organizational picture of the web application under development. This comprehensive view is beneficial to the developer.

It should be noted that in various additional and/or alternative embodiments of the present invention, any compatible tag-based markup language may be used, as long as a relationship between the markup language and the corresponding procedural language that underlies the web application. The relationship may be a direct relationship, such as the relationship between MXML™ and ACTIONSCRIPT™ in FLEX™, or it may be an indirect relationship, such as the relationship between DHTML and JAVASCRIPT™ in AJAX. Moreover, markup languages, such as MXML™, may be implemented to compile down into a variety of different procedural languages. While MXML™ currently compiles to ACTIONSCRIPT™, future languages may be modeled on the same paradigm of compiling a tag-based declarative language to a procedural language. As such, similarly modeled declarative languages may be configured to compile down to other procedural languages, such as JAVASCRIPT™, Microsoft Corporation's C#™, and the like.

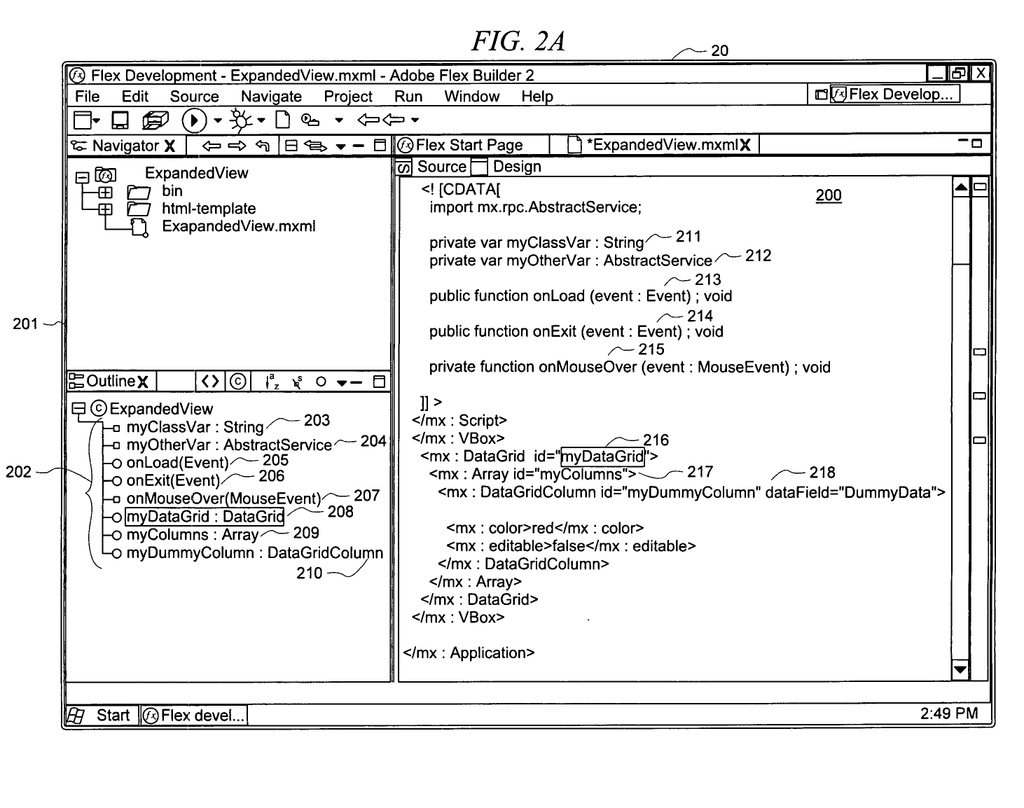

FIG. 2A is a screenshot illustrating ADE 20 configured according to one embodiment of the present invention. ADE 20 allows the developer to code applications using MXML™. Code listing 200 includes the MXML™ code that defines the application under development in ADE 20. Outline view panel 201 provides the developer an organizational overview of the application. FIG. 2A illustrates outline view panel 201 displaying the procedural outline 202. Procedural outline 202 provides a list of various procedural elements available in code listing 200. A visual identifier is associated with each displayed element that visually identifies the type of element, such as components, variables, functions, and the like. ADE 20 partially compiles the MXML™ code in code listing 200 to come up with procedural outline 202. Partially compiling performs much of the same compilation as actual compiling would perform, except without creating an actual executable file.

Moreover, each element listed in procedural outline 202 corresponds to an entry in code listing 200. For example, myClassVar:String 203 corresponds to the variable definition at line 211; myOtherVar:AbstractService 204 corresponds to the variable definition at line 212; on Load(Event) 205 corresponds to the on Load function at line 213; on Exit(Event) 206 corresponds to the on Exit function at line 214; on MouseOver(MouseEvent) 207 corresponds to the on MouseOver function at line 215; myDataGrid:Datagrid 208 corresponds to the DataGrid entry at line 216; myColumns:Array 209 corresponds to the array entry at line 217; and myDummyColumn:DataGridColumn 210 corresponds to the DataGridColumn entry at line 218. Therefore, by glancing at outline view panel 201, the developer has an overview of the procedural related elements of code listing 200. Furthermore, ADE 20 provides a visual relationship between the elements shown in outline view panel 201 and code listing 200. As illustrated in FIG. 2A, myDataGrid:DataGrid 208 is highlighted in outline view panel 201. The corresponding entry at line 216 is also highlighted, which allows the developer to easily traverse between different sections of declarative code found in code listing 200 that corresponds to the more procedural aspect of the application.

It should be noted that in additional and/or alternative embodiments of the present invention, other computer languages with a relation between a declarative language and a procedural language may be used. For example, in the AJAX environment, the procedural view of the DHTML code may comprise an outline of all of the property IDs in the DHTML that can be manipulated or accessed using the JAVASCRIPT™ procedural language.

FIG. 2B is a screenshot illustrating ADE 20 configured according to one embodiment of the present invention. As the developer works with code listing 200, he or she may also desire to view the declarative tree-view of code listing 200 to get an overview of the hierarchical relationship between the various declarative visual elements of the web application. Outline view panel 201 presents declarative tree-view 219. Declarative tree-view 219 displays a hierarchical listing of the various visual elements from code listing 200. Many visual properties are applicable to different screen objects depending on the hierarchical relationship of the objects. Therefore, declarative tree-view 219 provides a visual representation of that hierarchical relationship as a tree. As in procedural outline 202 (FIG. 2A), the elements listed in declarative tree-view 219 correspond to elements found in code listing 200. For example, script entry 220 corresponds to script section 230 in code listing 200; VBox 221 corresponds to the VBox entry at line 227; DataGrid:myDataGrid 222 corresponds to the DataGrid entry at line 216; Array myColumns 223 corresponds to the array entry at line 217; DataGridColumn myDummyColumn 224 corresponds to the DataGridColumn entry at line 218; color entry 225 corresponds to the color entry at line 228; and editable entry 226 corresponds to the editable entry at line 229. Therefore, while some of the elements overlap between procedural outline 202 (FIG. 2A) and declarative tree-view 219, there are many different elements between the two outline views. The difference arises because of the differences between the procedural and declarative function. By presenting an overview to the developer of both, the developer can more easily manage the organization of the entire application.

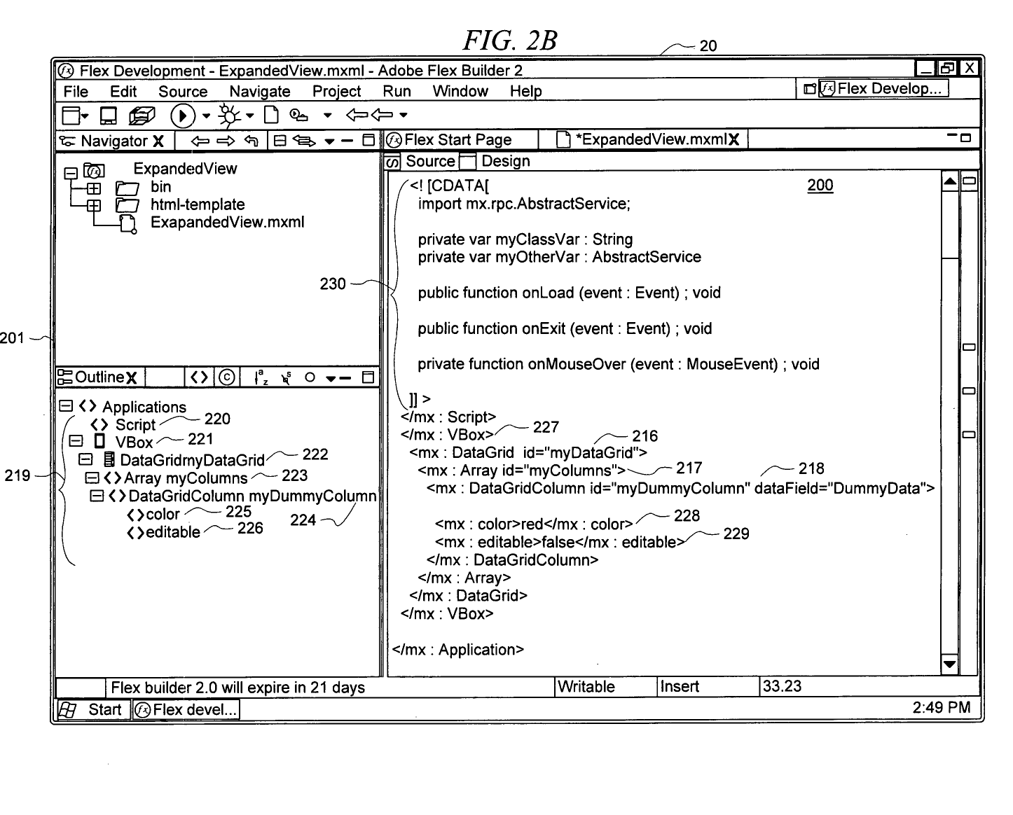

FIG. 3 is a flowchart illustrating example steps executed to implement one embodiment of the present invention. In step 300, a selection indicator is presented to a user in an ADE for selecting to view either a procedural code outline view or a declarative tree-view of an application that is defined, at least in part, by a tag-based markup language. A signal is received, in step 301, to present the procedural code outline view of the application. The application is processed, in step 302, to obtain a procedural code representation of the application using a relationship between the tags defining the application and the procedural code. In step 303, the procedural code outline view is generated from the procedural code representation. Another signal is received, in step 304, to present the declarative tree-view of the application. The application is parsed, in step 305, to obtain a declarative object model of the application. In step 306, the declarative tree-view of the application is created using the declarative object model.

The program or code segments making up the various embodiments of the present invention may be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, and the like. The computer data signal may include any signal that can propagate over a transmission medium such as electronic network channels, optical fibers, air, electromagnetic, RF links, and the like. The code segments may be downloaded via computer networks such as the Internet, Intranet, and the like.

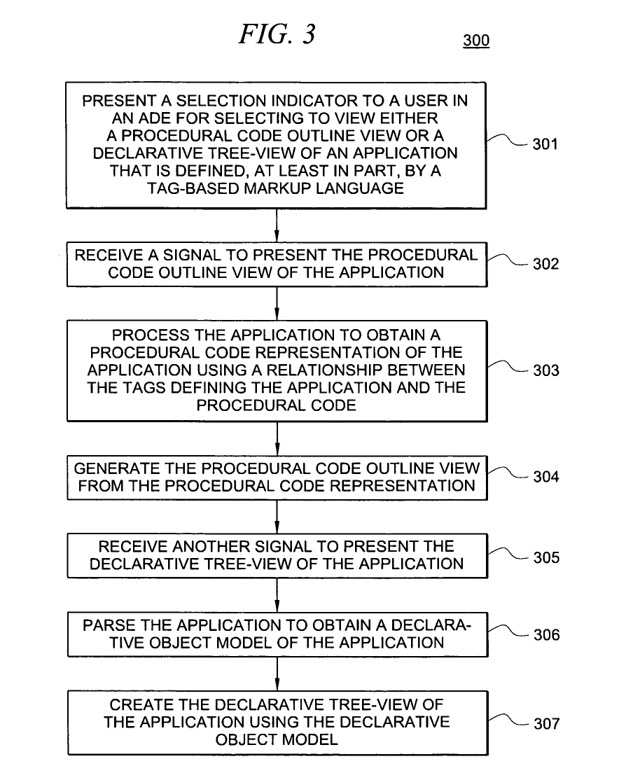

FIG. 4 illustrates computer system 400 adapted to use embodiments of the present invention, e.g. storing and/or executing software associated with the embodiments. Central processing unit (CPU) 401 is coupled to system bus 402. The CPU 401 may be any general purpose CPU. However, embodiments of the present invention are not restricted by the architecture of CPU 401 as long as CPU 401 supports the inventive operations as described herein. Bus 402 is coupled to random access memory (RAM) 403, which may be SRAM, DRAM, or SDRAM. ROM 404 is also coupled to bus 402, which may be PROM, EPROM, or EEPROM. RAM 403 and ROM 404 hold user and system data and programs as is well known in the art.

Bus 402 is also coupled to input/output (I/O) controller card 405, communications adapter card 411, user interface card 408, and display card 409. The I/O adapter card 405 connects storage devices 406, such as one or more of a hard drive, a CD drive, a floppy disk drive, a tape drive, to computer system 400. The I/O adapter 405 is also connected to a printer (not shown), which would allow the system to print paper copies of information such as documents, photographs, articles, and the like. Note that the printer may be a printer (e.g., dot matrix, laser, and the like), a fax machine, scanner, or a copier machine. Communications card 411 is adapted to couple the computer system 400 to a network 412, which may be one or more of a telephone network, a local (LAN) and/or a wide-area (WAN) network, an Ethernet network, and/or the Internet network. User interface card 408 couples user input devices, such as keyboard 413, pointing device 407, and the like, to the computer system 400. The display card 409 is driven by CPU 401 to control the display on display device 410.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1-27. (canceled)

28. A method comprising:
receiving, by at least one processor, an application file comprising tag-based code and procedural components, the procedural components corresponding to a procedural language;
identifying the procedural components, by at least one processor; and
generating a procedural outline view, by at least one processor, based on the identified procedural components, the procedural outline view at least substantially comprising procedural components.

29. The method of claim 28 wherein identifying the procedural components comprises:
parsing the tag-based code; and
determining the procedural components based at least in part on the parsed tag-based code.

30. The method of claim 29 wherein parsing the tag-based code comprises:
creating an object model for the tag-based code.

31. The method of claim 28 wherein identifying the procedural components comprises:
at least partially compiling the application file; and
determining the procedural components based at least in part on the at least partially compiled application file.

32. The method of claim 28 wherein identifying the procedural components comprises:
identifying potential procedural components in the application file; and
for each potential procedural component:
comparing the potential procedural component to a list of previously determined procedural components for the procedural language to determine whether the potential procedural component is a procedural component.

33. The method of claim 32 wherein the list of previously determined procedural components is stored in at least one database.

34. The method of claim 28 wherein identifying the procedural components comprises:
referencing a data store to determine the procedural components.

35. The method of claim 28 further comprising:
displaying a visual indicator associated with at least one of the procedural components in the procedural outline view.

36. The method of claim 35 wherein the visual indicator identifies a type of procedural component.

37. The method of claim 28 wherein at least one of the procedural components identifies at least one of a class, a variable, or a function in the application file.

38. The method of claim 28 wherein at least one of the procedural components comprises an element corresponding to a function.

39. The method of claim 28 wherein the procedural outline view does not comprise tag-based code.

40. The method of claim 28 wherein the procedural outline view comprises only procedural components.

41. The method of claim 28 further comprising:
identifying declarative components in the application file; and
generating a declarative outline view based on the identified declarative components, the declarative outline view at least substantially comprising declarative components.

42. A system comprising:
a memory; and
a processor in communication with the memory, the processor configured for:
analyzing an application file comprising tag-based code and procedural components, the procedural components corresponding to a procedural language;
identifying the procedural components; and
generating a procedural outline view based on the identified procedural components, the procedural outline view at least substantially comprising procedural components.

43. The system of claim 42 wherein identifying the procedural components comprises:
parsing the tag-based code; and
determining the procedural components based at least in part on the parsed tag-based code.

44. The system of claim 42 wherein identifying the procedural components comprises:
at least partially compiling the application file; and
determining the procedural components based at least in part on the at least partially compiled application file.

45. The system of claim 42 wherein identifying the procedural components comprises:
identifying potential procedural components in the application file; and
for each potential procedural component:
comparing the potential procedural component to a list of previously determined procedural components for the procedural language to determine whether the potential procedural component is a procedural component.

46. The system of claim 42 wherein identifying the procedural components comprises:
referencing a data store to determine the procedural components.

47. The system of claim 42 wherein the processor is further configured for:
displaying a visual indicator associated with at least one of the procedural components in the procedural outline view.

48. The system of claim 42 wherein the processor is further configured for:
identifying declarative components in the application file; and
generating a declarative outline view based on the identified declarative components, the declarative outline view at least substantially comprising declarative components.

49. A non-transitory computer-readable medium comprising program code, the program code configured for:
receiving an application file comprising tag-based code and procedural components, the procedural components corresponding to a procedural language;
identifying the procedural components; and
generating a procedural outline view based on the identified procedural components, the procedural outline view at least substantially comprising procedural components.

50. The non-transitory computer-readable medium of claim 49 wherein identifying the procedural components comprises program code configured for:
parsing the tag-based code; and
determining the procedural components based at least in part on the parsed tag-based code.

51. The non-transitory computer-readable medium of claim 49 wherein identifying the procedural components comprises program code configured for:
at least partially compiling the application file; and
determining the procedural components based at least in part on the at least partially compiled application file.

52. The non-transitory computer-readable medium of claim 49 wherein identifying the procedural components comprises program code configured for:
identifying potential procedural components in the application file; and
for each potential procedural component:
comparing the potential procedural component to a list of previously determined procedural components for the procedural language to determine whether the potential procedural component is a procedural component.

53. The non-transitory computer-readable medium of claim 49 wherein identifying the procedural components comprises program code configured for:
referencing a data store to determine the procedural components.

54. The non-transitory computer-readable medium of claim 49 further comprising program code configured for:
displaying a visual indicator associated with at least one of the procedural components in the procedural outline view.

55. The non-transitory computer-readable medium of claim 49 further comprising program code configured for:
identifying declarative components in the application file; and
generating a declarative outline view based on the identified declarative components, the declarative outline view at least substantially comprising declarative components.
